(19) United States
(12) Patent Application Publication
(10) Pub. No.: US 2005/0100425 A1
(43) Pub. Date: May 12, 2005

(54) Fastener assembly

(76) Inventor: Hung-Ming Wu, Pu-Tzu City (TW)

Correspondence Address: FROMMER LAWRENCE & HAUG, 745 FIFTH AVENUE- 10TH FL., NEW YORK, NY, 10151, US

(21) Appl. No.: 10/704,472

(22) Filed: Nov. 7, 2003

(51) Int. Cl. F16B 37/14

(52) U.S. Cl. 411/372.5

(57) ABSTRACT

A fastener assembly includes a protective cover having an annular part, a cap, and a connecting strip interconnecting elastically the annular part and the cap. A fastening member has a head, a retention flange extending radially and outwardly from a bottom end of the head, an abutting flange that is reduced in diameter and that extends co-axially from the retention flange, and a screw rod that is reduced in diameter and that extends co-axially from the abutting flange. The abutting flange has a thickness greater than that of the annular part of the cover and a diameter smaller than that of a through-hole in the annular part of the cover. The retention flange has a diameter greater than that of the through-hole in the annular part of the cover.

### BACKGROUND OF THE INVENTION

1. Field of the Invention

The present invention relates to a fastener assembly, more particularly to a fastener assembly with a fastening member and a protective cover that is freely rotatable relative to the fastening member when coupled to the fastening member.

2. Description of the Related Art

Referring to FIG. 1, a conventional fastener assembly is shown to include a protective cover 13 and a fastening member 11. The protective cover 13 includes an annular part 132 defining a through-hole 135, a cap 131, and a connecting strip 133 interconnecting elastically the annular part 132 and the cap 131. The fastening member 11 includes a head 111 with a bottom end, an abutting flange 113 extending radially and outwardly from the bottom end of the head 111, and a screw rod 112 that is reduced in diameter and that extends co-axially from the abutting flange 113. The abutting flange 113 has a diameter greater than that of the through-hole 135 in the annular part 132 of the protective cover 13.

When the aforesaid conventional fastener assembly is used to fasten two workpieces 121, 122 together, as shown in FIG. 2, the screw rod 112 of the fastening member 11 is extended through the through-hole 135 in the annular part 132 of the protective cover 13 and the upper workpiece 121 to engage threadedly the lower workpiece 122 with the abutting flange 113 of the fastening member 11 pressing the annular part 132 of the protective cover 13 against the upper workpiece 121. The cap 131 is sleeved on the head 111 so as to protect the fastening member 11 from corrosion and for safety purposes.

The aforesaid conventional fastener assembly is disadvantageous in that the annular part 132 of the protective cover 13 tends to twist and break upon tightening of the fastening member 11 and that the position of the annular part 132 of the protective cover 13 cannot be altered due to tight abutment of the abutting flange 113 against the annular part 132, which, in turn, makes mounting of the cap 131 onto the head 111 of the fastening member 11 difficult.

### SUMMARY OF THE INVENTION

Therefore, the object of this invention is to provide a fastener assembly which is capable of overcoming the aforesaid disadvantages of the prior art.

According to the present invention, the fastener assembly includes: a protective cover and a fastening member. The protective cover includes an annular part, a cap, and a connecting strip interconnecting elastically the annular part and the cap. The annular part defines a through-hole. The fastening member includes a head with a bottom end, a retention flange extending radially and outwardly from the bottom end of the head, an abutting flange that is reduced in diameter and that extends co-axially from the retention flange, and a screw rod that is reduced in diameter and that extends co-axially from the abutting flange, the abutting flange having a thickness greater than that of the annular part of the protective cover and a diameter smaller than that of the through-hole in the annular part of the protective cover so as to extend through the through-hole when the protective cover is coupled to the fastening member, the retention flange having a diameter greater than that of the through-hole in the annular part of the protective cover.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of a conventional fastener assembly;

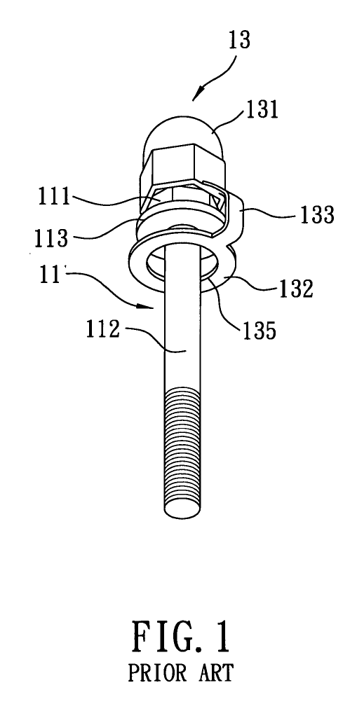

FIG. 2 is a schematic partly sectional view illustrating how the conventional fastener assembly fastens two workpieces together;

FIG. 3 is a perspective view of the first preferred embodiment of a fastener assembly according to the present invention;

FIG. 4 is a schematic partly sectional view illustrating how the first preferred embodiment of the fastener assembly fastens two workpieces together; and

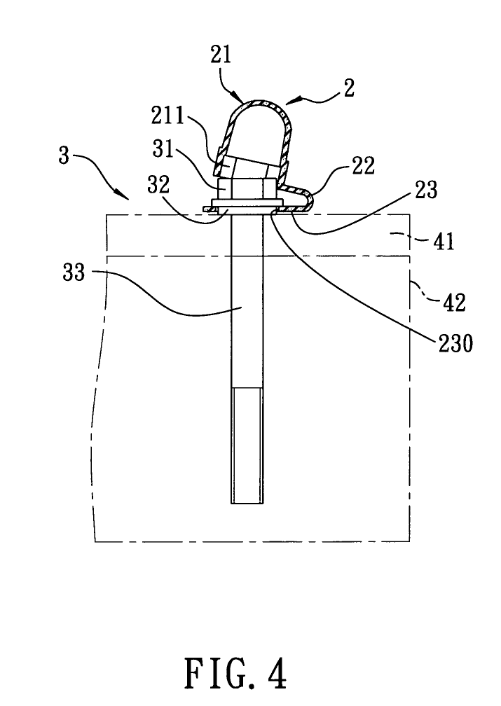

FIG. 5 is a perspective view of the second preferred embodiment of a fastener assembly according to the present invention.

### DETAILED DESCRIPTION OF THE PREFERRED EMBODIMENTS

Before the present invention is described in greater detail with reference to the following preferred embodiments, it should be noted that same reference numerals have been used to denote similar elements throughout the specification.

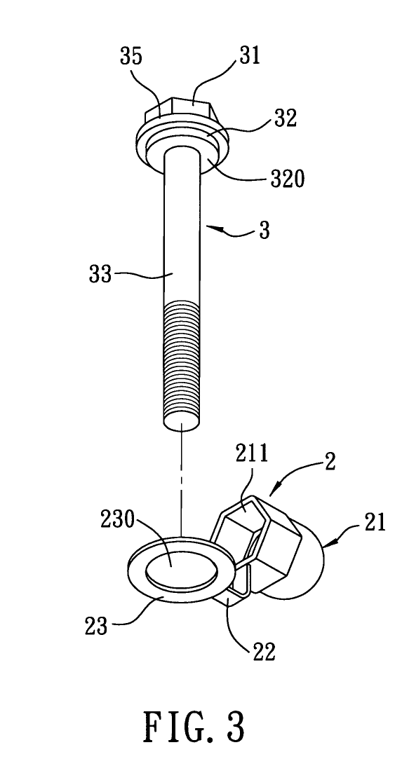

Referring to FIG. 3, the first preferred embodiment of a fastener assembly according to the present invention is shown to include a protective cover 2 and a fastening member 3.

The protective cover 2 is made from elastic material, and includes an annular part 23, a cap 21 with a polygonal portion 211, and a connecting strip 22 interconnecting elastically the annular part 23 and the polygonal portion 211 of the cap 21. The annular part 23 defines a through-hole 230.

The fastening member 3 is made from metal, and includes a polygonal head 31 with a bottom end, a retention flange 35 that extends radially and outwardly from the bottom end of the head 31, an abutting flange 32 that is reduced in diameter and that extends co-axially from the retention flange 35, and a screw rod 33 that is reduced in diameter and that extends co-axially from the abutting flange 32. The abutting flange 32 has a thickness greater than that of the annular part 23 of the protective cover 2, and a diameter smaller than that of the through-hole 230 in the annular part 23 of the protective cover 2. The retention flange 35 of the fastening member 3 has a diameter greater than that of the through-hole 230 in the annular part 23 of the protective cover 2.

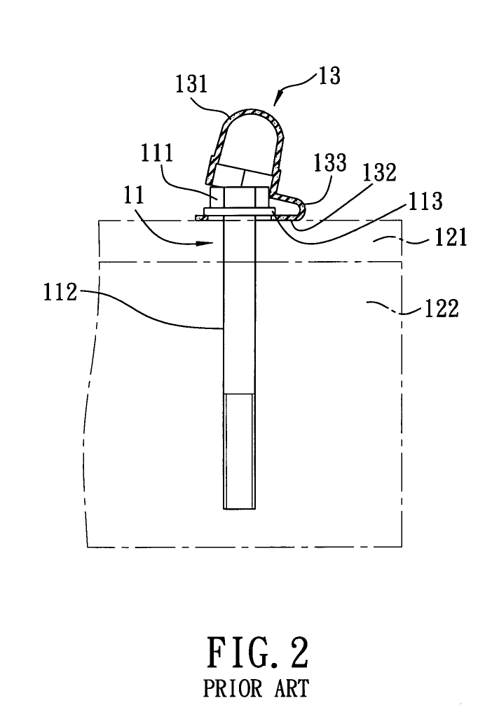

When the fastener assembly of the present invention is used to fasten two workpieces 41, 42 together, as shown in FIG. 2, the screw rod 33 of the fastening member 3 is extended through the through-hole 230 in the annular part 23 and an upper one of the workpieces 41 to engage threadedly a lower one of the workpieces 42. The abutting flange 32 of the fastening member 3 is extended through the through-hole 230 in the annular part 23 to abut against the upper one of the workpieces 41. Since the annular part 23 is movable around the abutting flange 32, the polygonal portion 211 of the cap 21 can be easily sleeved on the head 31 to conceal the head 31 underneath the cap 21, to ensure safety. Moreover, twisting and breaking of the connecting strip 22 can be prevented.

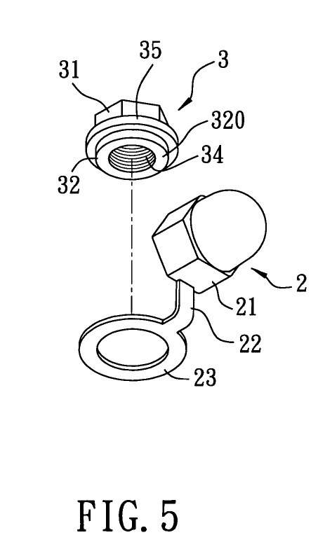

Referring to FIG. 5, the second preferred embodiment of a fastener assembly according to the present invention is shown to have a construction similar to that of the previous embodiment. The main difference resides in that the abutting flange 32 of the fastening member 3 has a bottom end face 320 and is formed with an inner threaded hole 34 that extends inwardly thereof. A conventional bolt (not shown) can be connected to the fastening member 3 by extending into and threadedly engaging the threaded hole 34 in the bottom end face 320 of the abutting flange 32.

Like the previous embodiment, the cap 21 can be easily mounted on the head 31 to eliminate the aforesaid disadvantages of the prior art.

With this invention thus explained, it is apparent that numerous modifications and variations can be made without departing from the scope and spirit of this invention. It is therefore intended that the invention be limited only as indicated in the appended claims.

1. A fastener assembly comprising:
a protective cover which includes an annular part, a cap, and a connecting strip interconnecting elastically said annular part and said cap, said annular part defining a through-hole; and
a fastening member including a head with a bottom end, a retention flange extending radially and outwardly from said bottom end of said head, an abutting flange that is reduced in diameter and that extends co-axially from said retention flange, and a screw rod that is reduced in diameter and that extends co-axially from said abutting flange, said abutting flange having a thickness greater than that of said annular part of said protective cover and a diameter smaller than that of said through-hole in said annular part of said protective cover so as to extend through said through-hole when said protective cover is coupled to said fastening member, said retention flange having a diameter greater than that of said through-hole in said annular part of said protective cover.

2. A fastener assembly comprising:
a protective cover which includes an annular part, a cap, and a connecting strip interconnecting elastically said annular part and said cap, said annular part defining a through-hole; and
a fastening member including a head with a bottom end, a retention flange extending radially and outwardly from said bottom end of said head, and an abutting flange that is reduced in diameter and that extends co-axially from said retention flange, said abutting flange having a thickness greater than that of said annular part of said protective cover and a diameter smaller than that of said through-hole in said annular part of said protective cover, said retention flange having a diameter greater than that of said through-hole in said annular part of said protective cover, said abutting flange further having a bottom end face formed with an inner threaded hole that extends inwardly from said bottom end face.
